(19) United States
(12) Patent Application Publication
(10) Pub. No.: US 2024/0194975 A1
(43) Pub. Date: Jun. 13, 2024

(54) COOLING SYSTEM FOR AN ELECTRONIC SYSTEM

(71) Applicant: VALEO SYSTEMES THERMIQUES, La Verriere (FR)

(72) Inventors: Cedric DE VAULX, La Verriere (FR); Kamel AZZOUZ, La Verriere (FR); Jeremy BLANDIN, La Verriere (FR); Yolanda BRAVO, La Verriere (FR)

(73) Assignee: VALEO SYSTEMES THERMIQUES, La Verriere (FR)

(21) Appl. No.: 18/554,317

(22) PCT Filed: Apr. 7, 2022
(86) PCT No.: PCT/EP2022/059188

§ 371 Date: Oct. 6, 2023

(30) Foreign Application Priority Data
Apr. 7, 2021 (FR) FR2103557

(51) Int. Cl. H01M 10/6557; H01M 10/613; H01M 10/615; H01M 10/625; H01M 10/653

(52) U.S. Cl. CPC H01M 10/6557; H01M 10/613; H01M 10/615; H01M 10/625; H01M 10/653; H01M 2220/20

(57) ABSTRACT

The present invention relates to an electronic system module that includes a plurality of electrical and/or electronic components, at least one temperature control element configured so as to adjust a temperature of at least one first electrical and/or electronic component and placed opposite a portion of the first electrical and/or electronic component, the temperature control element being placed between the first electrical and/or electronic component and a second electrical and/or electronic component adjacent to the first electrical and/or electronic component. The module includes at least one protective component in which the temperature control element is at least partially embedded, the protective component being at least partially in contact with the plurality of electrical and/or electronic components.

### TECHNICAL FIELD

The present invention relates to the field of cooling systems for electronic systems and electrical or electronic components equipping such an electronic system.

### BACKGROUND OF THE INVENTION

Electrical and/or electronic components of an electronic system to which the present invention can relate can consist equally of computer server components and components of electrical energy storage systems, in particular batteries, for motor vehicles.

Some motor vehicles, such as electric or hybrid vehicles, include one or more batteries for powering an electric drive motor. The electric battery typically comprises a plurality of energy storage modules arranged side by side and electrically connected. Each energy storage module comprises a plurality of electrical energy accumulators. Each electrical energy accumulator is intended for the reversible storage of electrical energy in electrochemical form.

The battery in a motor vehicle functions optimally when its temperature is within an optimum value range. When the battery temperature falls below a minimum threshold value in this range, particularly in winter, the battery's internal resistance rises sharply and its ability to deliver optimum performance diminishes. When the battery's temperature rises above a maximum threshold value in the optimum value range, for example as a result of load on the battery during operation of the vehicle's engine, or as a result of recharging the battery, this affects the battery's thermodynamic state by varying its open-circuit potential, which in turn can reduce the battery's performance and/or state of charge.

In addition, variations in battery temperature contribute greatly to the acceleration of battery ageing. Battery temperature must therefore be controlled to remain within the optimum temperature range specific to this battery, and thus offer adequate performance while avoiding premature ageing.

To this end, hybrid or electric motor vehicles can be fitted with thermal management systems to heat or cool the battery's electrical energy accumulators. In particular, such a thermal management system is capable of taking into account the battery's operating mode and the surrounding conditions, and adapting the thermal response according to the data taken into account.

Such a thermal management system can include a heat exchanger equipped with channels through which a heat transfer fluid circulates. Depending on the heat treatment applied upstream to this heat transfer fluid, the latter can be used to facilitate the capture of heat generated by the accumulators in order to cool them, or to supply heat to heat up the accumulators.

To optimize the heat transfer between the heat exchanger and the accumulators, the channels are positioned as close as possible to the accumulators. However, heat transfer is limited by the existing air layer between the outer wall of the channels and the accumulators, in particular due to the manufacturing clearances of each of these components and the assembly clearances. What's more, these channels can only be located at one end of the accumulators, making it difficult to achieve a homogeneous temperature within the accumulator itself. Lastly, the various components mentioned above have low resistance to mechanical shocks, which can render the battery unusable.

The invention forms part of this context and has the objective of providing an alternative for thermal regulation devices for electronic systems containing electrical and/or electronic components, whether these are computer servers, batteries of motor vehicles or any other type of electronic system having components which are liable to heat up during their operation or while they are being charged. The aim of the present invention is to overcome at least one of the aforementioned disadvantages, and also to lead to other advantages, by proposing a new type of electronic system, and for example a new type of energy storage module for an electric vehicle battery, particularly an automotive battery.

### BRIEF SUMMARY OF THE INVENTION

The present invention thus proposes an electronic system module which comprises a plurality of electrical and/or electronic components, at least one thermal regulation component configured to adjust a temperature of at least a first electrical and/or electronic component and arranged opposite a portion of the first electrical and/or electronic component, said thermal regulation component being arranged between the first electrical and/or electronic component and a second electrical and/or electronic component adjacent to the first electrical and/or electronic component. The electrical energy storage module comprises at least one protective component in which the thermal regulation component is at least partially embedded, said protective component being in contact with at least part of the plurality of electrical and/or electronic components, preferably in contact with at least part of all the electrical and/or electronic components.

The thermal regulation component can be configured to only heat the electrical and/or electronic components in the vicinity of this thermal regulation component, or to only cool them, or to have an alternative heating and cooling action.

A special feature of the electronic system module is that it includes a protective component making it possible to protect the thermal regulation component and/or the electrical and/or electronic components from mechanical impact. In addition, the protective component enables the thermal regulation component(s) and the electrical and/or electronic components to be held in position. Furthermore, the fact that each thermal regulation component is embedded in the protective component, combined with the fact that the protective component is in contact with at least some of the electrical and/or electronic components, prevents air from circulating or stagnating between a thermal regulation component and an electrical and/or electronic component. As a result, heat transfer between these two parts is increased.

The protective component and the thermal regulation component described above, according to the invention, can be associated in particular with an electrical and/or electronic component of the electrical energy accumulator type present in an electronic system of the electrical storage device type, otherwise known as a battery, of a motor vehicle.

The present invention then proposes an electrical energy storage module, in particular an electric battery, for a vehicle which comprises a plurality of electrical energy accumulators, at least one thermal regulation component configured to adjust a temperature of at least a first electrical energy accumulator and arranged opposite a portion of the first electrical energy accumulator, said thermal regulation component being arranged between the first electrical energy accumulator and a second electrical energy accumulator adjacent to the first electrical energy accumulator. The electrical energy storage module comprises at least one protective component in which the thermal regulation component is at least partially embedded, said protective component being in contact with at least part of the plurality of electrical energy accumulators, preferably in contact with at least part of all the electrical energy accumulators.

The function of the heat management device is to regulate the temperature of the battery, for example by cooling it during operation, or by preheating the battery during start-up.

In one embodiment, the thermal regulation component comprises at least one flexible body and at least one device for connection to a supply network, said connection device being arranged at one end of the flexible body. The term ‘flexible body’ should be understood to mean that this component can be given a curved geometric configuration, which can be random and different from one thermal regulation component to another within the protective component.

In one embodiment, the flexible body is a hollow fiber configured to channel a heat transfer fluid. Depending on the thermal treatment of the heat transfer fluid before it enters the thermal regulation component, the latter can then cool only, heat only, or alternatively heat and cool the electrical and/or electronic component(s).

Advantageously, the heat transfer fluid can in particular consist of cooling liquid, for example glycolated water, or refrigerant fluid, for example 1234YF or 134A.

In one embodiment, the flexible body is a resistive electric wire, or a flexible heating component. Each electrical wire or each flexible heating component is associated with a connection device linked to an electrical network specific to the electronic system, such as the vehicle's storage module. In the case of an electronic system formed by a motor vehicle battery, it is possible to heat the electrical and/or electronic components via the resistive electrical wires or flexible heating components, embedded in the protective component, using the electrical energy stored in the vehicle's electric battery or secondary battery.

According to one embodiment, the thermal regulation component is a metal heating plate. In this way, electrical and/or electronic components can be heated using electrical energy stored in the vehicle's electric battery or secondary battery.

In one embodiment, the energy storage module comprises a casing forming a housing for the plurality of electrical and/or electronic components, the thermal regulation component and the protective component.

In one embodiment, the thermal regulation component is connected to an inlet supply arranged on a wall of the casing and an outlet supply also arranged on a wall of the casing. In particular, the thermal regulation component is connected to the inlet and outlet supplies via a thermal regulation component connection device. The inlet supply can be arranged on one wall of the casing, and the outlet supply can be arranged on another wall of the casing. It is also possible for the inlet supply and outlet supply to be arranged on the same wall of the casing. The inlet power supply and the outlet power supply can be electrical. The inlet supply and outlet supply can be channel outlets for circulating heat transfer fluid.

In one embodiment, the electrical energy storage module comprises a plurality of thermal regulation components arranged between the electrical and/or electronic components, forming a mesh around at least some of the electrical and/or electronic components, preferably around all the electrical and/or electronic components. This facilitates thermal management of the electrical and/or electronic components.

Here and in all that follows, ‘mesh’ means that the plurality of thermal regulation components form a network that surrounds at least some of the electrical and/or electronic components. The thermal regulation components can be interconnected and all connected, via their own connection device(s), to the same electrical conduit or circuit extending into the casing between the inlet supply and the outlet supply of the casing. Alternatively, each thermal regulation component can be directly connected to an inlet and outlet supply formed on the casing of the storage module, provided that the latter comprises as many inlet and outlet supplies as there are thermal regulation components. Alternatively, a thermal regulation component can share a connection device with at least one other thermal regulation component.

According to one embodiment, the thermal regulation component is a first thermal regulation component and said module comprises a second thermal regulation component configured to adjust the temperature of the first electrical and/or electronic component and arranged opposite another portion of the first electrical and/or electronic component. In this context, a first thermal regulation component and a second thermal regulation component can be arranged on either side of the same electrical and/or electronic component, or they can also be superimposed on each other and extend opposite the same surface of the same electrical and/or electronic component, at different heights. As a result, thermal management of the first electrical and/or electronic component is improved. This can also make it possible to assign a distinct function to each thermal regulation component.

In one embodiment, the module comprises a plurality of second thermal regulation components arranged between the electrical and/or electronic components, forming a mesh around the electrical and/or electronic components, preferably around all the electrical and/or electronic components. This improves the thermal management of the electrical and/or electronic components.

In one embodiment, the mesh size of the plurality of second thermal regulation components is substantially identical to the mesh size of the plurality of first thermal regulation components.

According to one embodiment, the electrical and/or electronic components are arranged one after the other in a direction of elongation of the storage module, said storage module comprising a plurality of second thermal regulation components arranged between the electrical and/or electronic components, the first and second thermal regulation components being arranged alternately between two adjacent electrical and/or electronic components in this direction of elongation.

In one embodiment, the second thermal regulation component comprises at least one flexible body and at least one network connection device arranged at one end of the flexible body.

In one embodiment, the flexible body is a hollow fiber configured to channel a heat transfer fluid. Depending on the thermal treatment of the heat transfer fluid before it enters the thermal regulation component, the latter can then cool only, heat only, or alternatively heat and cool the electrical and/or electronic component(s).

In one embodiment, the flexible body is a resistive electrical wire. As mentioned above, electrical and/or electronic components can be heated using electrical energy stored in the vehicle's electric battery or secondary battery.

In one embodiment, the second thermal regulation component is a flexible heating component or a metal heating plate.

In one embodiment, the protective component has a thermal conductivity greater than or equal to 0.25 W/(m·K) at 20° C. This then improves heat transfer between the thermal regulation components and the electrical and/or electronic components.

According to one embodiment, the protective component has an electrical resistivity greater than or equal to 10+11 Ω·cm at 20° C. This reduces the risk of short-circuiting.

According to an embodiment, the protective component comprises at least one polyepoxide layer. The polyepoxide layer can be obtained by polymerizing the epoxy monomer compound in the presence of a crosslinking agent under the effect of heat.

In one embodiment, the protective component includes at least one ceramic material with a thermal conductivity greater than or equal to 20 W/(m·K) at 20° C. This then improves the thermal conductivity of the protective component.

The ceramic material or the ceramic materials can be incorporated in the polyepoxide layer.

According to one embodiment, the ceramic material has an electrical resistivity greater than or equal to 10+11 Ω·cm at 20° C. This improves the electrical resistivity of the polyepoxide layer and therefore of the protective component.

In one embodiment, the ceramic material is selected from the group comprising aluminum nitride (AlN), alumina (Al2O3) and mixtures thereof. The advantages of aluminum nitride include, in particular, very high thermal conductivity, very high electrical insulation capacity and low thermal expansion. Alumina has the particular advantage of being less expensive than aluminum nitride and of having a flame-retardant effect.

The invention also relates to an electronic system, for example an electric battery for a motor vehicle, comprising at least one electronic system module having at least one previously described feature.

The invention can further relate to a vehicle comprising at least one electric battery having at least one previously described feature. The vehicle can be a motor vehicle, a two- or three-wheeled electric motorized road vehicle, an electric velocipede, or an electric scooter.

A further object of the invention is a method for assembling the electronic system module, comprising a step of arranging the plurality of electrical and/or electronic components and the thermal regulation component in the module casing, and a step of polymerizing an epoxy monomer-type compound in the presence of a crosslinking agent poured into said heated casing so as to obtain the protective component.

### BRIEF DESCRIPTION OF THE DRAWINGS

Further features and advantages of the invention will become more clearly apparent both from the following description and from a number of exemplary embodiments, which are given by way of non-limiting indication with reference to the attached schematic drawings, in which:

FIG. 1 is a schematic representation of an electronic system, here a motor vehicle electric battery, comprising a plurality of modules according to a first embodiment of the invention;

FIG. 2 is a schematic representation of a module from FIG. 1;

FIG. 3 is a schematic representation of an electrical and/or electronic component suitable for the electronic system module shown in FIG. 2;

FIG. 4 is a schematic representation of a thermal regulation component suitable for equipping the electronic system module shown in FIG. 2;

FIG. 5 is a schematic representation of a portion of an electronic system module according to a second embodiment of the invention; and

FIG. 6 is a schematic representation of a portion of an electronic system module according to a third embodiment of the invention.

### DETAILED DESCRIPTION OF THE INVENTION

It should first of all be noted that, although the figures set out the invention in detail for the implementation thereof, they can of course be used to better define the invention, where appropriate. It should also be noted that, in all of the figures, components that are similar and/or perform the same function are indicated using the same numbering.

The invention relates in particular to an electronic system module which is special in that it comprises at least one component for thermal regulation of at least one electrical and/or electronic component and a protective component, and in that the protective component envelops the thermal regulation component and is in contact with the plurality of electrical and/or electronic components.

In the description below, an electronic system module will be described in greater detail for an electronic system in the form of a motor vehicle battery with electrical and/or electronic components in the form of electrical energy accumulators. It should however be noted that the following description can apply to electronic systems of another type such as computer servers for example.

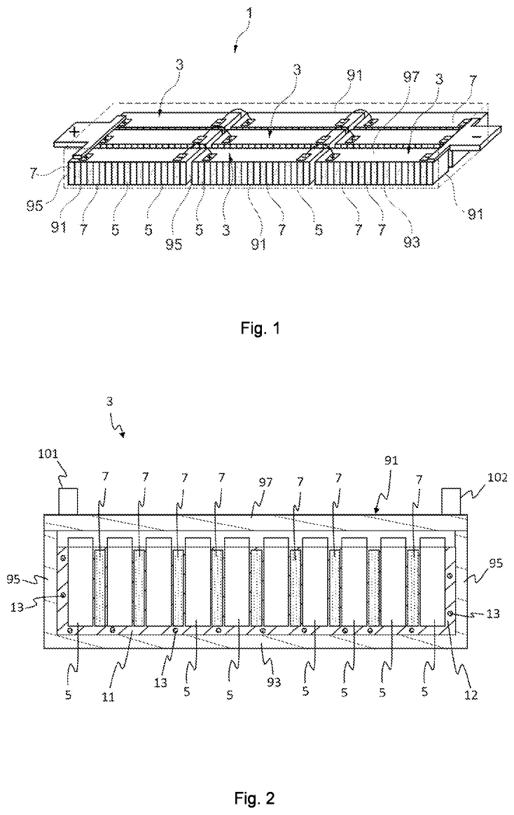

With particular reference to FIGS. 1 and 2, a plurality of electrical energy storage modules 3 are illustrated, each comprising a plurality of electrical energy accumulators 5, a plurality of thermal regulation components 7, and a protective component 11. Such electrical energy storage modules 3 can form an electrical battery 1. The electric battery 1 can be used in any vehicle, for example a motor vehicle, a two- or three-wheel motorized electric road vehicle, an electric velocipede, or an electric scooter.

The electrical energy storage module 3 comprises a casing 91, the walls 93, 95, 97 of which form a housing for the plurality of electrical energy accumulators 5, the plurality of thermal regulation components 7, and the protective component 11. The electrical energy storage module 3 can be mounted by first arranging the plurality of accumulators and the thermal regulation components 7 in the casing 91. The protective component 11 is configured to be injected into the casing 91 so as to at least partially embed the thermal regulation components 7 and the electrical energy accumulators 5 and so as to fix their position after polymerization of a crosslinking agent, as will be discussed below.

In the illustrated example, the casing 91 has a parallelepiped shape with six walls 93, 95, 97, including, as shown in particular in FIG. 2, a bottom wall 93, side walls 95, and a closing cover 97.

The casing 91 also includes an inlet supply 100 and an outlet supply 101, which can be connected to an electrical supply network and/or a fluidic supply network, in order to appropriately supply the thermal regulation components housed inside the casing. The inlet supply 100 and the outlet supply 101 are arranged on a wall of the casing, preferably on the top wall 97. In an embodiment not shown, the inlet supply can be arranged on one wall of the casing and the outlet supply can be arranged on another wall of the casing.

The electrical energy accumulators 5 are held in position by the protective component 11, wherein the thermal regulation components 7 are encapsulated, the protective component resting on the bottom wall 93 and against the side walls 95 of the casing 91. The electrical energy accumulators 5 are in contact with the protective component 11 over the majority of their outer surface. The protective component 11 thus makes it possible to ensure the positioning of the electrical energy accumulators 5 relative to each other, relative to the thermal regulation components 7, and relative to the walls of the casing 91.

Details will be given below regarding the properties of the protective component 11, particularly with regard to its thermal conduction properties, which enable the transfer of heat between the electrical energy accumulators 5 and the thermal regulation components 7.

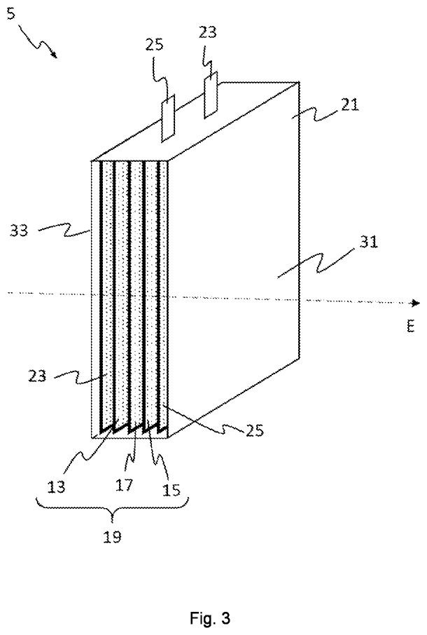

With reference to FIG. 3, each electrical energy accumulator 5 comprises at least one positive electrode 13, at least one negative electrode 15 and at least one separator 17. The electrical energy accumulators 5 are each assembled by stacking the positive electrode 13, the negative electrode 15 and the separator 17, which is interposed between the two electrodes 13, 15. The separator 17 can be impregnated with a solution containing at least one electrolyte.

This stack forms an electrochemical core 19 which is then placed in a sleeve 21 so that a positive terminal 23 and a negative terminal 25 of the electrical energy accumulator 5, visible in FIG. 3, are accessible from outside the sleeve 21 and can be connected to a supply network within the vehicle's electrical battery 1.

The sleeve 21 forms a sealed enclosure that protects the electrochemical core 19 from air and moisture. In the example shown in the figures, the sleeve 21 consists of a substantially flat pocket, and the electrodes 13, 15 and separator 17 stacked in a stacking direction E within this sleeve 21 consists of a superposition of substantially flat layers. In particular, the main surfaces of the sleeve, and therefore the main surfaces of the corresponding electrical energy accumulator, can be defined as the surfaces perpendicular to the stacking direction, substantially perpendicular to the various layers of the electrochemical core just mentioned. In particular, one main surface 31 and another main surface 33 are shown in FIG. 3.

In the first embodiment shown in FIG. 1 and FIG. 2, electrical energy accumulators 5 have a substantially flat shape as shown in FIG. 3, and each thermal regulation component 7 is interposed between two adjacent electrical energy accumulators. Each thermal regulation component 7 thus faces at least a portion of each of the two accumulators. As can be seen in FIG. 2, each thermal regulation component 7 is arranged to be able to adjust the temperature of a portion of the two electrical energy accumulators 5 adjacent thereto. In other words, each thermal regulation component 7 is arranged opposite one of the main surfaces 31, 33 of the sleeve 21, this main surface extending in a plane perpendicular to the stacking direction E previously defined.

The thermal regulation component 7 comprises a flexible body 8 and at least one connection device 6, 10 arranged at one end of the flexible body, said connection device enabling connection to a supply network, whether this is an electrical or fluidic supply network.

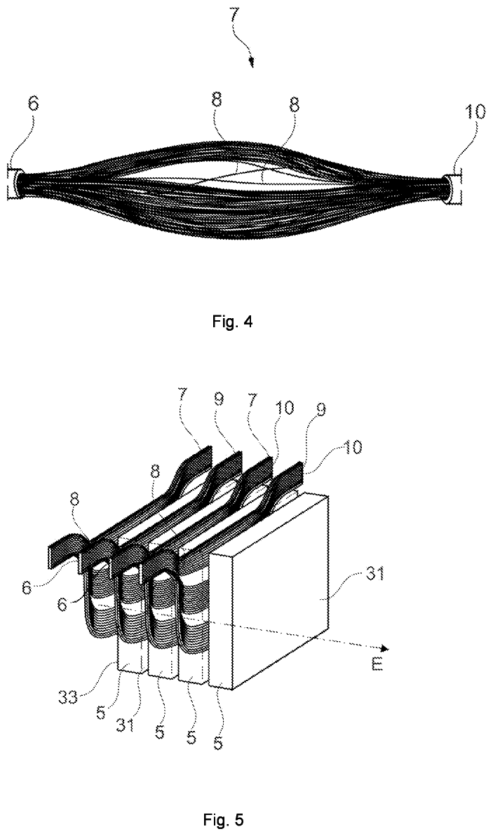

More precisely, the flexible body of the thermal regulation component 7 is here a bundle of hollow fibers 8 in which each hollow fiber 8 is configured to channel a heat transfer fluid as illustrated more precisely in FIG. 4.

The hollow fibers 8 can be made of a polymeric material. The use of such a material gives these hollow fibers sufficient mechanical strength and chemical resistance to withstand the stresses to which they are subjected. In addition, such a material makes it possible to obtain flexible microfibers, i.e. these hollow fibers 8 can be deformed, bent, without their integrity being impacted.

Each hollow fiber has a cross-section with a main dimension of between 0.5 mm and 1.5 mm. Each hollow fiber 8 has an extension dimension greater than the distance between the two connection devices 6, 10, each of which assumes a predefined position in the casing for connection to the appropriate supply network. Thus, between these two rigid connection devices and in the fixed position, each hollow fiber can be shaped, randomly, to cover a large area of the main surface 31 of the casing 21 opposite which the thermal regulation component 7 is located.

Each thermal regulation component 7 comprises at least one connection device, in this case a heat transfer fluid inlet connection device 6 and a heat transfer fluid outlet connection device 10, with hollow fibers respectively connected at each of their ends to the connection devices so as to circulate the heat transfer fluid in the hollow fibers. In this way, the ends of each hollow fiber 8 open out into the connection devices 6, 10, each of which acts as a collector to recover the fluid via the inlet and outlet feeds 100, 101 associated with the casing 91 and connected to the fluid supply network external to the casing.

It is thus possible to connect the thermal regulation components to a thermal system (not shown), for example a heat pump, to be able to heat and/or cool the electrical energy accumulators 5.

In an embodiment not illustrated, the thermal regulation component is a resistive wire or a flexible heating component. The body of the thermal regulation component is again enclosed in the protective component and is capable of rising in temperature to give heat to the accumulators in contact with the protective component. One end of the thermal regulation component then emerges from the protective component and takes on the role of the aforementioned connection device 6, to be connected to an electrical network, thus enabling the thermal regulation component to be supplied with electricity and to heat up. It is understood that only one connection device is required here, and not two as described for microfibers intended to be traversed by a heat transfer fluid. In these embodiments, it is therefore possible to heat the accumulators using the electrical energy stored in the vehicle's electric battery or secondary battery.

Alternatively, a thermal regulation component could be provided in which the body is formed by a metal heating plate or by a rigid fluidic channel plate. It is understood that such embodiments do not go beyond the scope of the invention, insofar as the body of the thermal regulation component is at least partially engaged in the protective component, thereby optimizing the heat transfer between the body of the thermal regulation component and the adjacent accumulator.

As previously mentioned, the protective component 11 is made from a material chosen in particular for its heat-conducting properties. In particular, the protective component 11 has a thermal conductivity greater than or equal to 0.25 W/(m K) at 20° C. This makes it possible to improve the heat exchange between the electrical energy accumulator 5 and the thermal regulation component 7. The protective component 11 also has an electrical resistivity greater than or equal to 10+11 Ω·cm at 20° C. so as to prevent any short-circuit in which it might be involved.

In the example shown in FIG. 2, the protective component 11 comprises a single polyepoxide layer 12 and a ceramic material distributed within the polyepoxide layer 12. Without departing from the context of the invention, the protective component could result from the superposition of a layer of polyepoxide and a layer of ceramic material. Alternatively, the protective component could be formed by a single layer of polyepoxide or a layer of ceramic material.

The polyepoxide layer 12 can be obtained from an epoxy monomer compound. The polyepoxide layer 12 can be produced by polymerizing the epoxy monomer compound in the presence of a crosslinking agent under the effect of heat. In an embodiment not shown, the protective component 11 comprises a plurality of polymer layers in addition to the polyepoxide layer 12.

The crosslinking agent makes it possible to create chemical bonds, either chemically or physically, between the macromolecular chains formed by polymerization of the epoxy monomer compound. This improves the mechanical resistance of the polyepoxide layer 12, in particular to impact, and hence of the protective component 11.

The ceramic material 13 has a thermal conductivity greater than or equal to 20 W/(m K) at 20° C. and an electrical resistivity greater than or equal to 10+11 Ω·cm at 20° ° C. The presence of at least one ceramic material 13 in the protective component 11 enhances the mechanical strength of the protective component 11. The ceramic material 13 also improves the thermal conductivity and electrical resistivity of the protective component 11. The ceramic material can form part of the polyepoxide layer 12, as illustrated in the embodiment shown in FIG. 2.

The ceramic material is selected from the group comprising aluminum nitride (AlN), alumina (Al2O3), and mixtures thereof. In the illustrated embodiment, the polyepoxide layer 12 comprises aluminum nitride and alumina.

Aluminum nitride has the advantage of having a very high thermal conductivity, a high electrical insulation capacity, and a low thermal expansion. For example, aluminum nitride has a thermal conductivity of between 170 and 200 W/(m·K) at 20° C. and an electrical resistivity greater than or equal to 1.1014 Ω·cm at 20° C.

Alumina, also known as aluminum oxide, has an electrical resistivity of between 1.1014 and 1.1015 Ω·cm and a thermal conductivity of between 20 and 30 W/(m K). In addition, alumina has a mechanical strength of between 300 and 630 MPa and a compressive strength of 2,000 to 4,000 MPa, making it an additive that increases the mechanical strength of the polyepoxide layer 12 and therefore the mechanical strength of the protective component 11. Furthermore, alumina has a density of between 3750 and 3950 kg/m3, which is lighter than most metal parts. Lastly, alumina has a flame-retardant effect, making it possible to delay the start of a fire when the electric battery 1 is running away.

As previously mentioned, the electrical energy storage module 3 can be assembled by first arranging the plurality of accumulators and the thermal regulation components 7 in the casing 91. To ensure that the parts are correctly arranged in relation to one another and at a distance from the bottom wall 93, the walls 93, 95, 97 of the casing 91 can be fitted with centring components, not shown.

Next, an epoxy monomer compound in the presence of a cross-linking agent is poured into the casing 91 so that the bodies of the thermal regulation components are immersed in the compound, it being understood that the connection devices 6, 10 arranged at the ends of the body of the thermal regulation components are not covered with this compound. The electrical energy accumulators 5 are, for their part, partially immersed in the epoxy monomer compound.

The casing 91 is then heated to allow polymerization of the epoxy monomer compound to thus form the protective component 11.

The ceramic materials 13 are added to the epoxy monomer compound before it is poured into the casing 91. It should be noted that the heating operation is not necessary to polymerize the resin, as the hardener can function at room temperature.

According to a variant of the method, heating and/or cross-linking agent might not be used. According to another method variant, the protective component 11 can first be manufactured by positioning the thermal regulation components in a suitable mold, into which the previously described compounds are added to produce the polyepoxide layer 12. After demolding, the protective component 11, in which the thermal regulation components are embedded, is inserted into the casing 91. The electrical energy accumulators are then placed in the casing 91 at the points provided for in the protective component 11 during molding.

FIG. 5 illustrates a second embodiment of the electrical energy storage module which differs from the first embodiment in that the thermal regulation components are grouped into two separate sets, namely a first set of thermal regulation components and a second set of thermal regulation components.

In particular, this second embodiment is used in a storage module in which the accumulators are arranged one after the other along a direction of elongation of the storage module, here parallel to the stacking direction E visible in FIG. 5, and in which the thermal regulation components are respectively arranged between two successive accumulators considering this direction of elongation.

The sets of thermal regulation components are made up of identical thermal regulation components from one set to the next, conforming to the thermal regulation component 7 described above, but differing in their thermal regulation function. The first set has the sole function of cooling the electrical energy accumulators, and the second set has the sole function of heating the electrical energy accumulators.

The thermal regulation components of the first set will hereinafter be referred to as first control components 7. The thermal regulation components of the second set will hereinafter be referred to as the second control components 9.

For identical components between the first and second embodiments, which are designated by the same references, please refer to the description of FIGS. 1 to 4 described above.

Referring to FIG. 5, the electrical energy storage module comprises a plurality of second thermal regulation components 9. The second thermal regulation components 9 are identical to the first thermal regulation components 7 shown in FIG. 4. The second thermal regulation components 9 are then bundles of hollow fibers 8, each hollow fiber 8 being configured to channel a heat transfer fluid. Each second thermal regulation component 9 comprises a connection device 6 for the heat transfer fluid inlet 6 and a connection device 10 for the heat transfer fluid outlet, so as to circulate the heat transfer fluid in the hollow fibers.

The first thermal regulation components 7 are configured to cool part of the electrical energy accumulators 5. The inlet connection device 6 and the outlet connection device 10 of the first thermal regulation components 7 are connected, via the inlet 100 and outlet 101 supplies of the casing 91, to a refrigeration circuit not shown.

The second thermal regulation components 9 are configured to heat a further part of the electrical energy accumulators 5. The inlet connection device 6 and the outlet connection device 10 of the second thermal regulation components 9 are connected to a heating circuit not shown. In one embodiment, the second thermal regulation components can consist of resistive electrical wires.

The first thermal regulation components 7 and the second thermal regulation components 9 are arranged between the electrical energy accumulators 5 in an alternating manner, considering the previously mentioned direction of elongation of the storage module. In other words, an electrical energy accumulator 5 will be interposed between a first thermal regulation component 7 and a second thermal regulation component 9. A main surface 31 of the electrical energy accumulator 5 can thus be cooled by the first thermal regulation component 7 and another main surface 33 of the same electrical energy accumulator 5 opposite the main surface 31 can be heated by the second thermal regulation component 9.

The energy storage module 5 according to this second embodiment can be obtained by the assembly method previously described for the energy storage module 5 according to the first embodiment. In this context, the second thermal regulation components 9 are arranged in the casing 91 simultaneously with the first thermal regulation components 7, prior to the epoxy monomer addition step.

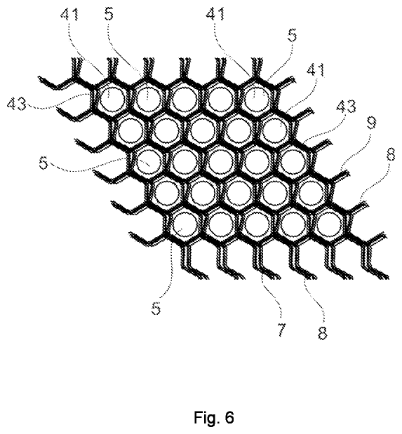

FIG. 6 illustrates a third embodiment of the electrical energy storage module which differs from the second embodiment in that the electrical energy accumulators 5 have a cylindrical sleeve 21, instead of the parallelepiped shape described in the other embodiments, and inside which the stack of electrodes and separator also have a rolled-up shape for accommodation in the sleeve. The third embodiment is also special in that the first thermal regulation components 7 and the second thermal regulation components 9 are arranged differently.

With reference to FIG. 6, since the electrical energy accumulators 5 are generally cylindrical in shape, the sleeve can be defined with two end surfaces 41 connected by a radial main surface 43. It should be noted that, as previously mentioned, the main surface, here radial, of the sleeve is perpendicular to a stacking direction of the electrochemical core layers 19. The hollow fibers 8 of the first thermal regulation components 7 are arranged opposite the radial main surface of the casing 21 and thus of the electrical energy accumulator 5. The hollow fibers 8 form a mesh such that the thermal regulation components 7 surround each electrical energy accumulator 5.

Similarly to what has been described for the first thermal regulation components 7, the hollow fibers 8 of the second thermal regulation components 9 form a mesh so that the second thermal regulation components 9 surround each electrical energy accumulator. More specifically, the second thermal regulation components 9 are arranged radially with respect to the electrical energy accumulators 5 so as to form a second mesh around all the electrical energy accumulators 5. In this third embodiment, the second mesh is substantially identical to the first mesh.

The hollow fibers 8 of the second thermal regulation components 9 forming the second mesh are superimposed on the hollow fibers 8 of the first thermal regulation components 7 forming the first mesh, this superimposition being relative to a direction parallel to the axis of the cylinder defining the electrical energy accumulator. In other words, the first thermal regulation components 7 are arranged opposite a first portion of the electrical energy accumulators 5, which can in particular consist of half the axial dimension of these accumulators, and the second thermal regulation components 9 are arranged opposite another portion of the electrical energy accumulators 5, axially offset with respect to the first portion, and which can in particular consist of the other half of the axial dimension of these accumulators.

The superposition, or juxtaposition, of the first thermal regulation components 7 and the second thermal regulation components 9 along the direction parallel to the cylinder axis, enables each thermal regulation component 7, 9 to be in the vicinity of the radial main surface 43 of the electrical energy accumulators to have a thermal regulation effect.

In this embodiment, the first thermal regulation components 7 are connected to a heating circuit for heating the electrical energy accumulators 5 and the second thermal regulation components 9 are connected to a cooling circuit for cooling the electrical energy accumulators 5. In an embodiment not shown, the first thermal regulation components 7 can consist of resistive electrical wires.

The energy storage module 5 according to this third embodiment can be obtained by the assembly method previously described in the first embodiment for the energy storage module 5 according to the first embodiment. As in the second embodiment, the second thermal regulation components 9 are in this context arranged in the casing 91 simultaneously with the first thermal regulation components 7, before the step in which the epoxy monomer is added.

Of course, the invention is not limited to the examples that have just been described and numerous modifications can be made to these examples without departing from the scope of the invention.

What is claimed is:

1. An electronic system module for a vehicle, comprising a plurality of electrical and/or electronic components with a first electrical and/or electronic component and a second electrical and/or electronic component, at least one thermal regulation component configured so as to adjust a temperature of the first electrical and/or electronic component and placed opposite a portion of the first electrical and/or electronic component, said at least one thermal regulation component being placed between the first electrical and/or electronic component and the second electrical and/or electronic component adjacent to the first electrical and/or electronic component, said electronic system module further comprising at least one protective component in which the at least one thermal regulation component is at least partially embedded, said at least one protective component being at least partially in contact with the plurality of electrical and/or electronic components.

2. The electronic system module as claimed in claim 1, wherein the at least one thermal regulation component includes at least one flexible component and at least one connection device for connection to a supply network, said at least one connection device being arranged at one end of the at least one flexible component.

3. The electronic system module as claimed in claim 1, further comprising a casing forming a housing for the plurality of electrical and/or electronic components, the at least one thermal regulation component and the at least one protective component, and wherein the at least one thermal regulation component is connected to an inlet supply arranged on a wall of the casing and an outlet supply arranged on a wall of the casing.

4. The electronic system module as claimed in claim 1, further comprising a plurality of the thermal regulation components arranged between the plurality of the electrical and/or electronic components, forming a mesh around at least a part of the electrical and/or electronic components of the plurality of the electrical and/or electronic components.

5. The electronic system module as claimed in claim 1, wherein the at least one thermal regulation component is a first thermal regulation component, said electronic system module further comprising a second thermal regulation component configured to adjust the temperature of the first electrical and/or electronic component and arranged opposite another portion of the first electrical and/or electronic component.

6. The electronic system module as claimed in claim 5, further comprising a plurality of the thermal regulation components arranged between the plurality of the electrical and/or electronic components, forming a mesh around at least a part of the electrical and/or electronic components of the plurality of the electrical and/or electronic components, the electronic system module further comprising a plurality of second thermal regulation components arranged between the plurality of the electrical and/or electronic components, forming a mesh around the electrical and/or electronic components of the plurality of the electrical and/or electronic components, the mesh of the plurality of second thermal regulation components being substantially identical to the mesh of the plurality of first thermal regulation components.

7. The electronic system module as claimed in claim 5, wherein the electrical and/or electronic components of the plurality of the electrical and/or electronic components are arranged one after the other in a direction of elongation of the electronic system module, said electronic system module further comprising a plurality of second thermal regulation components arranged between the electrical and/or electronic components of the plurality of the electrical and/or electronic components, the first and second thermal regulation components being arranged alternately between two adjacent electrical and/or electronic components of the plurality of the electrical and/or electronic components in this direction of elongation.

8. The electronic system module as claimed in claim 1, wherein the at least one protective component has a thermal conductivity greater than or equal to 0.25 W/(m·K) at 20° C. and an electrical resistivity greater than or equal to 10-11 Ω·cm at 20° ° C.

9. The electronic system module as claimed in claim 1, wherein the at least one protective component includes at least one ceramic material having a thermal conductivity greater than or equal to 10 W/(m·K) at 20° C.

10. An electronic system comprising at least one electronic system module for a vehicle, including a plurality of electrical and/or electronic components with a first electrical and/or electronic component and a second electrical and/or electronic component, at least one thermal regulation component configured so as to adjust a temperature of the first electrical and/or electronic component and placed opposite a portion of the first electrical and/or electronic component, said at least one thermal regulation component being placed between the first electrical and/or electronic component and the second electrical and/or electronic component adjacent to the first electrical and/or electronic component, said electronic system module further comprising at least one protective component in which the at least one thermal regulation component is at least partially embedded, said at least one protective component being at least partially in contact with the plurality of electrical and/or electronic components.

11. The electronic system module as claimed in claim 1, wherein the at least one protective component has a thermal conductivity greater than or equal to 0.25 W/(m·K) at 20° ° C. or an electrical resistivity greater than or equal to 10-11 Ω·cm at 20° ° C.
